(19) United States
(12) Patent Application Publication
(10) Pub. No.: US 2002/0168533 A1
(43) Pub. Date: Nov. 14, 2002

(54) METHOD OF INHIBITING OXIDATION ON A METAL SURFACE WITH A POLYMER INCORPORATING A SURFACTANT MONOMER

(76) Inventors: JAMES W. TAYLOR, GURNEE, IL (US); JOHN P. WIRUTH, RACINE, WI (US)

Correspondence Address: JOHNSON POLYMER, INC., 8310 16TH STREET- M/S 510, P.O. BOX 902, STURTEVANT, WI, 53177-0902, US

(21) Appl. No.: 09/395,237

(22) Filed: Sep. 13, 1999

(51) Int. Cl. B32B 15/08

(52) U.S. Cl. 428/463; 427/388.4; 428/462

(57) ABSTRACT

A method of inhibiting oxidation on a metal surface is provided. The method includes applying coating composition containing a polymer incorporating at least one surface-active containing macromonomer to a metal surface. Oxidation of the metal surface is inhibited when the metal surface is contacted with an aqueous salt solution.

### FIELD OF THE INVENTION

The present invention relates to a method of inhibiting oxidation on a metal surface by applying a coating composition containing a polymer incorporating a surface-active containing macromonomer to the metal surface. The present invention also relates to a coated metal surface resistant to oxidation.

### BACKGROUND OF THE INVENTION

Metals are used in numerous applications important to everyday life. For example, metals are commonly used in the manufacture of automobiles, trucks, ships, airplanes, jets, cranes, tractors, bridges, homes, appliances, and other commercially important applications.

It has long been known that metal surfaces are prone to oxidation, especially when they are exposed to salt spray or salt water. Oxidation of metals is thus particularly problematic in areas where exposure to salt spray occurs. Examples of such areas include seaside locations, and areas where salt is used to melt ice during the winter.

Although various methods have been developed for retarding or inhibiting the oxidation of metals, a need still remains for polymers, coatings, and paints that inhibit the oxidation of metal surfaces to which they are applied.

U.S. Pat. No. 4,814,514 and U.S. Pat. No. 4,939,283 issued to Yokota et al. disclose certain surface-active compounds which have a polymerizable allyl or methallyl group. The surface-active compounds are disclosed as being particularly useful as emulsifiers in the emulsion or suspension polymerization of various monomers such that aqueous suspensions of the polymer particles are produced.

U.S. Pat. No. 5,332,854 and U.S. Pat. No. 5,324,862 issued to Yokota et al. disclose anionic and nonionic vinyl-aromatic surfactants capable of reacting with other monomers, and thus being incorporated into polymers, during polymerization reactions.

Various vinyl aromatic surfactants referred to as Noigen RN, a nonionic surfactant, and Hitenol BC, an anionic surfactant, are described in a technical bulletin published by DKS International, Inc. of Tokyo, Japan. Related polymerizable anionic surfactants referred to as Hitenol A-10 are similarly described in another technical bulletin published by the same entity. Both publications disclose the preparations of polymers containing the surfactants.

In WO 97/45495 Collins et al. disclose the preparation of water-based ink compositions containing a pigment and a polymer latex. The disclosed latex is either a non-carboxylic acid containing polymeric (polyamino) enamine latex or a mixture of a polymeric (polyamino) enamine latex and an acetoacetoxy-functional polymer latex. The polymeric (polyamino) enamine for use in the ink is disclosed as a reaction product of a surfactant-stabilized acetoacetoxy-functional polymer which may be prepared from a vinyl-containing anionic or nonionic reactive surfactant such as Hitenol RN, Hitenol HS-20, Hitenol A-10, and Niogen RN.

In WO 97/45490 Collins et al. disclose the composition, preparation, and end-use of waterborne compositions prepared from water-based latexes. The water-based latexes comprise dispersed, non-carboxylic acid containing waterborne polymeric amino-functional and acetoacetoxy-functional particles. The disclosed latex can be used in a variety of coating compositions such as paints, inks, sealants, and adhesives. Preparation of a surfactant-containing acetoacetoxy-functional polymer is disclosed which may be prepared using a vinyl-containing anionic or nonionic reactive surfactant such as Hitenol RN, Hitenol HS-20, Hitenol A-10, and Niogen RN.

In WO 97/45468 Collins et al. disclose the preparation and composition of surfactant-containing acetoacetoxy-functional polymers. The acetoacetoxy-functional polymers may be a surfactant-containing enamine-functional polymer, but is more preferably a surfactant-containing polymeric (polyamino) enamine. The disclosed non-carboxylic acid containing waterborne polymer compositions can be prepared with a high solids content while maintaining low viscosity, and the compositions are disclosed as useful in a variety of coating applications such as in paints, inks, sealants, and adhesives.

U.S. Pat. No. 5,539,073 issued to Taylor et al. discloses polymers useful in coating compositions. The polymers are prepared via free radical polymerization using ethylenically unsaturated monomers. Various reactive anionic and nonionic surfactants are disclosed as suitable surfactants for use in the disclosed emulsion polymerization process.

U.S. Pat. No. 5,783,626 issued to Taylor et al. discloses allyl-functional polymers having pendant enamine moieties and preferably also possessing pendant methacrylate groups. The patent also discloses that amino-containing waterborne particles can be prepared by reacting propylene imine with carboxylic acid-containing latexes. Such amino-functionalized latexes were reacted with acetoacetoxyethyl methacrylate. Vinyl-containing anionic and ionic surfactants are disclosed as components which can be added to processes used for preparing the acetoacetoxy-containing polymers.

Although a number of references have disclosed polymerizable surfactants and polymers incorporating such surfactants, none of the references discloses that the oxidation of metal surfaces coated with such polymers is inhibited when the coated surfaces are contacted by aqueous salt solutions.

### SUMMARY OF THE INVENTION

It would be highly desirable to have a method for inhibiting oxidation on metal surfaces which is accomplished by applying a coating composition to the surface. It would also be highly desirable to be able to produce an oxidation resistant metal surface.

The present invention provides a method of inhibiting oxidation on a metal surface. The method includes applying a coating composition containing a polymer incorporating at least one surface-active containing macromonomer to a metal surface. Oxidation of the resulting metal surface is inhibited when the metal surface is contacted with an aqueous salt solution.

In a preferred embodiment of the method of inhibiting oxidation on a metal surface, the surface-active containing macromonomer has the structure:

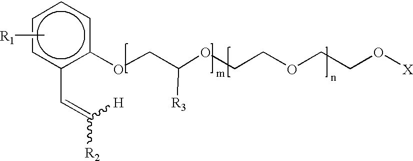

where: R1 is H, a halogen, or a C₁ to C₂₂ linear or branched chain hydrocarbon group; R2 is H, a halogen, or a linear or branched chain C₁ to C₆ linear or branched chain hydrocarbon and the zigzag lines represent that the R₂ group can be either cis or trans to the aromatic group; R3 is H, a halogen, or a C₁ to C₆ linear or branched chain hydrocarbon group; m is an integer ranging from 0 to 20; n is an integer ranging from 1 to 50; X is H, SO₃⁻Y, P(═O)(OH)₂, or a deprotonated form of P(═O)(OH)₂; and Y is a cation such as sodium, lithium, potassium, ammonium, monoalkylammonium, dialkylammonium, trialkylammonium, tetralkylammonium, or mixtures of these cations.

In another preferred embodiment of the method of inhibiting oxidation on a metal surface, the polymer further includes at least one acrylic monomer and at least one aromatic ethylenically-unsaturated monomer incorporated into the polymer. In more preferred embodiments, the polymer is a latex.

In another preferred embodiment of the method of inhibiting oxidation on a metal surface, the polymer further incorporates at least one vinyl ester monomer in addition to incorporating at least one acrylic monomer and at least one ethylenically-unsaturated monomer incorporated into the polymer. The vinyl ester monomer preferably has the formula H₂C═C(R₅)—O—C(═O)—R_{6,} where R₅ is either H or an alkyl group having from 1 to 5 carbon atoms and R₆ is an alkyl group having from 1 to 22 carbon atoms. In a more preferred embodiment, at least one of the carbon atoms of the R₆ alkyl group is bonded to at least three other carbon atoms.

In yet another preferred embodiment, the surface-active containing macromonomer is a vinyl aromatic surfactant monomer. In still other preferred embodiments, the acrylic monomer is acrylic acid, methacrylic acid, crotonic acid, an ester of acrylic acid, an ester of methacrylic acid, an ester of crotonic acid, a salt of acrylic acid, a salt of methacrylic acid, or a salt of crotonic acid while in other preferred embodiments, the aromatic ethylenically-unsaturated monomer is styrene, vinyltoluene, α-methylstyrene, t-butylstyrene, vinylxylene, or vinylpyridine.

In more preferred embodiments, the polymer further includes at least two acrylic monomers and at least one aromatic ethylenically-unsaturated monomer incorporated into the polymer. In still more preferred embodiments, at least one of the acrylic monomers is a hydroxyalkyl acrylate or methacrylate.

In certain preferred embodiments of the method of inhibiting oxidation of a metal surface, the polymer is substantially free of acetoacetoxy, amine, or enamine functionalities. In other preferred embodiments, the polymer is substantially free of any incorporated trimethylolpropane triacrylate. In still other preferred embodiments, the coating composition is substantially free of any flash rust inhibitor.

The invention also provides a method of inhibiting oxidation on a metal surface which includes coating the metal surface with a coating composition containing a polymer, the polymer consisting essentially of the residue of at least one surface-active containing macromonomer; the residue of at least one acrylic monomer; and the residue of at least one ethylenically-unsaturated aromatic monomer. Oxidation of the coated metal surface is inhibited when the surface is contacted with aqueous salt solutions.

The invention also provides a coated metal surface resistant to oxidation. The coated metal surface includes a metal surface and a coating composition coated on the metal surface. The coating composition includes a polymer that incorporates a vinyl-containing reactive surfactant monomer. Oxidation of the metal surface is inhibited when the coated metal surface is contacted with salt water.

In some preferred coated metal surfaces with oxidation resistant surfaces, the polymer further incorporates at least one acrylic monomer, preferably a hydroxylalkyl acrylate or methacrylate, incorporated into the polymer and at least one aromatic ethylenically unsaturated monomer incorporated into the polymer. In other preferred coated metal surfaces, the polymer is substantially free of acetoacetoxy, amine, or enamine functionalities and the polymer is substantially free of any incorporated trimethylolpropane triacrylate. In still other preferred coated metal surfaces with oxidation resistant surfaces, at least one of the acrylic monomers is acrylic acid, methacrylic acid, or crotonic acid while in other preferred embodiments, the coating composition is substantially free of a flash rust inhibitor.

Still further features and advantages of the invention will be apparent from the following detailed description.

### DETAILED DESCRIPTION OF THE INVENTION

A polymer “substantially free” of an item is a polymer that contains less than 2%, more preferably less than 1%, and most preferably less than 0.25% (w/w) of the item.

A coating composition “substantially free” of an item is a coating composition that contains less than 0.5% (w/w) of the item.

A polymer that has a monomer “incorporated” into it means that the monomer has reacted in a polymerization reaction and that the reacted monomer is chemically bonded or attached to the polymer.

Oxidation of a metal surface is “inhibited” and a coated metal surface is “resistant” to oxidation when a metal surface with an applied polymer of the invention is visually less oxidized than a similar metal surface with an applied polymer prepared using similar techniques, but without the vinyl-containing reactive surfactant as described herein when the metal surfaces are contacted with salt spray under similar conditions.

The present invention includes a method of inhibiting the oxidation of a metal surface. The method includes applying a polymer incorporating at least one surface-active containing macromonomer to a metal surface. Oxidation of the metal surface with the applied polymer is inhibited when the metal surface is contacted with an aqueous salt solution.

The oxidation of a wide variety of metal surfaces may be inhibited using the method of the present invention. For example, oxidation may be inhibited on metal surfaces, including but not limited to, iron, titanium, aluminum, copper, zinc, nickel, cobalt, chromium, magnesium, and other metals. The method of the present invention may also be used to protect alloys such as, but not limited to, steel.

The polymer may be applied to the metal surface using any technique known to those skilled in the art including, but not limited to, spray coating, brush coating, powder coating, and application with applicator blades.

The polymer applied to the metal surface is generally in an aqueous polymeric dispersion such as, but not limited to, a latex. However, the polymer may also be dissolved in an organic solvent and thus applied to the surface. Thus, the polymer may be painted on the metal surface using any of various techniques known to those skilled in the art. Additionally, the polymer may be applied in other forms including, but not limited to, as a powder coating or as a hot melt. A solution containing the polymer for application to the metal surface may contain various other ingredients as indicated below.

The polymer for use in the method of the present invention incorporates at least one surface-active containing macromonomer. The surface-active containing macromonomer is preferably a vinyl aromatic surfactant monomer and more preferably is a vinyl aromatic anionic or nonionic surfactant monomer. Preferred surface-active containing macromonomers for use in the present invention have the structure:

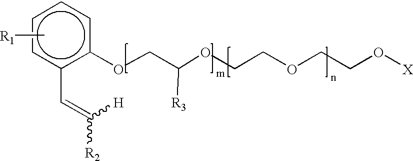

where: R1 is H, a halogen, or a C₁ to C₂₂ linear or branched chain hydrocarbon group; R2 is H, a halogen, or a linear or branched chain C₁ to C₆ linear or branched chain hydrocarbon and the zigzag lines represent that the R₂ group can be either cis or trans to the aromatic group; R3 is H, a halogen, or a C₁ to C₆ linear or branched chain hydrocarbon group; m is an integer ranging from 0 to 20; n is an integer ranging from 1 to 50; X is H, SO₃⁻Y, P(═O)(OH)₂, or a deprotonated form of P(═O)(OH)₂; and Y is a cation such as sodium, lithium, potassium, ammonium, monoalkylammonium, dialkylammonium, trialkylammonium, or tetralkylammonium.

The polymer for use in the method of the present invention preferably incorporates at least one acrylic monomer and at least one aromatic ethylenically-unsaturated monomer in addition to incorporating at least one surface-active containing macromonomer. More preferably, the polymer for use in the present invention incorporates at least one surface-active containing macromonomer, at least two different acrylic monomers, and at least one aromatic ethylenically-unsaturated monomer. In especially preferred embodiments the polymer incorporates at least one acrylic monomer containing a hydroxyl group such as hydroxyalkyl acrylates and methacrylates.

Various acrylic monomers may be incorporated in the polymer used in the present invention. Examples of acrylic monomers include, but are not limited to, acrylic acid, methacrylic acid, crotonic acid, esters of acrylic acid, esters of methacrylic acid, esters of crotonic acid, salts of acrylic acid, salts of methacrylic acid, and salts of crotonic acid.

Examples of acrylate and methacrylate monomers that may be incorporated in the polymer include, but are not limited to, methyl, ethyl, n-propyl, i-propyl, n-butyl, s-butyl, i-butyl, t-butyl, n-amyl, i-amyl, n-hexyl, 2-ethylbutyl, 2-ethylhexyl, n-heptyl, n-octyl, n-nonyl, n-decyl, cyclopentyl, cyclohexyl, benzyl, phenyl, cinnamyl, 2-phenylethyl, allyl, methallyl, propargyl, crotyl, 2-hydroxyethyl, 2-hydroxypropyl, 2-hydroxybutyl, 6-hydroxyhexyl, 5,6-dihydroxyhexyl, 2-methoxybutyl, 3-methoxybutyl, 2-ethoxyethyl, 2-butoxyethyl, 2-phenoxyethyl, glycidyl, furfuryl, tetrahydrofurfuryl, tetrahydropyryl, N,N-dimethylaminoethyl, N,N-diethylaminoethyl, N-butylaminoethyl, 2-chloroethyl, 3-chloro-2-hydroxypropyl, trifluoroethyl, and hexafluoroisopropyl acrylates and methacrylates. More preferred acrylates and methacrylates include alkyl acrylates and methacrylates such as the various isomers of methyl, ethyl, propyl, butyl, pentyl, hexyl, heptyl, octyl, n-nonyl, and n-decyl acrylates and methacrylates. Other preferred acrylates and methacrylates include hydroxyalkyl acrylates and methacrylates.

A variety of aromatic ethylenically-unsaturated monomers may be incorporated in the polymer for use in the present invention. For example, common aromatic ethylenically-unsaturated monomers include, but are not limited to styrene, vinyltoluene, α-methyl styrene, t-butyl styrene, vinylxylene, and vinylpyridine. More preferred aromatic ethylenically-unsaturated monomers include styrene and α-methyl styrene. Although some of the surface-active containing macromonomers incorporated in the polymer are aromatic surface-active containing macromonomers and could be classified as a type of aromatic ethylenically-unsaturated monomer, the term “aromatic ethylenically-unsaturated monomer” as used herein is defined to not include the surface-active containing macromonomer.

A variety of other monomers may be incorporated in the polymer for use in the present invention. One such monomer that may be incorporated in the polymer includes vinyl ester monomers. However, these are only preferred when an acrylic monomer is also incorporated in the polymer during the polymerization reaction. Preferred vinyl esters include, but are not limited to, those having the structure H₂C═C(R₅)—O—C(═O)—R_{6,} where R₅ is either H or an alkyl group having from 1 to 5 carbon atoms and R₆ is an alkyl group having from 1 to 22 carbon atoms. In a more preferred embodiment, at least one of the carbon atoms of the R₆ alkyl group is bonded to at least three other carbon atoms. Thus, more preferred vinyl ester monomers include those with a tertiary or quaternary carbon in the R₆ alkyl group. Examples of a few of these more preferred vinyl ester monomers include, but are not limited to: H₂C═C(R₅)—O—C(═O)—C(CH₃)₃, H₂C═C(R₅)—O—C(═O)—CH₂—(CH₃)₃, H₂C═C(R₅)—O—C(═O)—CH(CH₃)—CH₂—CH₃, H₂C═C(R₅)—O—C(═O)—CH₂—C(CH₃)₂—CH₂—CH₂—CH₂—CH₃, and H₂C═C(R₅)—O—C(═O))—C(CH₃)₂—CH₂—CH₃.

It is not necessary or required that the polymer for use in the method of inhibiting oxidation on a metal surface contain metal chelating groups such as acetoacetoxy, amine, or enamine groups. Rather, it has been found that metal surfaces with applied polymers that do not contain these groups inhibit the oxidation of the metal surface when the metal surface is contacted with aqueous salt solutions. However, these groups may be present if so desired. The fact that these groups can be excluded from the polymer for use in the present invention helps to reduce the costs associated with using monomers such as acetoacetoxyethyl methacrylate. Furthermore, because the polymer does not require any polymeric amine or enamine, acid-functional acrylic monomers such as, but not limited to, acrylic acid, methacrylic acid, and crotonic acid may be incorporated without any resulting cloudiness or flocculation. The polymer need also not contain trimethylolpropane as polymers prepared without this material have shown excellent application in inhibiting oxidation on metal surfaces while maintaining other desirable properties. Furthermore, excellent cross-linking of the polymer is possible through the use of hydroxyalkyl acrylate or hydroxyalkyl methacrylate monomers.

The polymer for use in the present invention may be prepared using any method known to those skilled in the art for incorporating radically-polymerizable ethylenically-unsaturated monomers into a polymer. The polymer may be prepared by continuous, semi-batch or batch processes using any type of reactor known to those skilled in the art. Various polymerization processes are disclosed in U.S. Pat. No. 4,414,370, U.S. Pat. No. 4,529,787, and U.S. Pat. No. 4,546,160 and these patents are herein expressly incorporated by reference in their entirety.

The polymer may also be prepared by emulsion polymerization techniques and methods known to those skilled in the art. For example, a suitable latex containing the reacted surface-active containing macromonomer may be prepared by adding a standard initiator such as, but not limited to, ammonium persulfate to an aqueous heated solution of a surface-active containing macromonomer such as Hitenol™ BC-20 available from DKS International, Inc. (Tokyo, Japan) while it is stirred in a resin kettle. A monomer feed containing additional monomers may then be added to the resulting mixture. For example, an emulsion feed containing more of the vinyl-containing reactant surfactant; acrylic monomers such as a mixture of methacrylic acid, 2-hydroxyethyl acrylate and ethyl acrylate; and an aromatic ethylenically-unsaturated monomer such as styrene or a mixture of aromatic, may be added to the solution.

The monomer feed may contain additional components such as, but not limited to, solvents and chain transfer agents. For example, any conventional chain transfer agent such as octyl mercaptopropionate may be present in the monomer feed. Once monomer addition is complete, oxidants such as ferrous sulfate may be added to the mixture followed by addition of initiators such as t-butyl hydroperoxide dissolved in aqueous solution containing isoascorbic acid and ammonium hydroxide.

The coating composition may be applied to the metal surface using any technique known to those skilled in the art. Thus, the polymer may be applied to the metal surface as a clear coat formulation. Alternatively, the polymer may be applied as one of several components in a paint. Such paints can be readily prepared by mixing a latex prepared as described above with a number of ingredients using conventional techniques. For example, the latex may be mixed with water, a conventional pigment such as, but not limited to, TiPure™ R-706 TiO₂ pigment available from E. I. DuPont de Nemours (Wilmington, Del.) and various conventional additives such as, but not limited to, organic solvents, defoamers, conventional surfactants, associative thickeners, plasticizers, flash rust inhibitors, and dispersants. Non-limiting representative examples of some of these components are Surfynol® CT-151 dispersant available from Rohm and Haas Company (Philadelphia, Pa.); Surfynol® 104DPM conventional surfactant available from Rohm and Haas Company (Philadelphia, Pa.); Dehydran® 1620 defoamer available from Henkel Corp. (Ambler, Pa.); DSX®-1550 associative thickener available from Henkel Corp. (Ambler, Pa.); RM-₈₂₅™ associative thickener available from Rohm and Haas Company (Philadelphia, Pa.); Butyl Cellosolve® diethylene glycol monobutyl ether and/or Hexyl Carbitol® diethylene glycol monohexyl ether both available from Union Carbide (Danbury, Conn.); KP-140® tributoxy ethyl phosphate available from FMC Corp. (Philadelphia, Pa.); and Raybo™ 60 flash rust inhibitor available from Raybo Chemical Company (Huntington, W. Va.).

Surprisingly and unexpectedly, it has been found that oxidation of the metal surface is inhibited even though the coating composition used to coat the metal surface does not contain any flash rust inhibitor or is substantially free of a flash rust inhibitor. As known by those skilled in the art, most flash rust inhibitors contain salts such as sodium nitrite which prevent oxidation. The fact that these can be eliminated allows for the reduction of salts in the coating composition. Additionally, it has been discovered that the amount of associative thickener included in an effective coating composition can be reduced when the polymer of the present invention is included. It is believed that the incorporation of the vinyl-containing surfactant into the polymer provides this beneficial result as the amount of free surfactant in the composition is minimized.

Oxidation of metal surfaces with a coating composition containing a polymer incorporating a vinyl-containing reactive surfactant applied to them is inhibited when the metal surface is contacted with salt water. Generally, the salt water is an aqueous salt solution with a pH of less than or equal to about 8.5, more preferably having a pH ranging from 7.5 to 8.5.

### EXAMPLES

### Example 1

### Preparation of a Latex Using Vinyl-Containing Reactive Surfactant Monomer

To a 3000 mL resin kettle equipped with a nitrogen purge, three-blade impeller, and condenser were charged 521 g of water and 3.5 g of a 10% solution of Hitenol™ BC-20 vinyl-containing reactive surfactant available from DKS International, Inc. (Tokyo, Japan). The surfactant solution was heated to 80° C. with stirring, then 1.38 g of ammonium persulfate dissolved in 20 g of water was pumped into the reactor over 5 minutes followed by addition of 7.5 g of water. An emulsion feed of 280 g of water, 6.65 g of Hitenol™ BC-20 (100%), 276.8 g of 2-hydroxyethyl acrylate, 276.80 g of styrene, 373.31 g of ethyl acrylate, 0.050 g of octyl mercaptopropionate, and 20.76 g of methacrylic acid was pumped into the reactor over 220 minutes. After the monomer emulsion addition was complete, an additional 16.0 g of water was pumped into the reactor. The water addition was followed by the addition of 1.0 g of ferrous sulfate solution (ferrous sulfate complexed with ethylenediaminetetraacetic acid (EDTA)). A solution of 1.7 g of t-butyl hydroperoxide dissolved in 15.0 g of water and a solution of 1.26 g of isoascorbic acid dissolved in 2.0 g of 28% ammonium hydroxide and 13.0 g of water were then pumped into the latex over 15 minutes. The latex was heated for an additional 20 minutes, and 28% ammonium hydroxide was then added to raise the pH to 8.9. The resulting latex was filtered through a 100-mesh wire screen. The following data was recorded for the latex: dried solids collected through the 100-mesh screen (0.015 g); percent solids in latex (42.61%); pH of latex (8.94); Mn (20,960); Mw (256,600); particle size (174.4 nm (Dn)); Tg (50° C.); minimum film formation temperature (30.3° C.); and surface tension (53 dyne/cm).

### Example 2

### Preparation of a Latex with a Conventional Surfactant

To a 3000 mL resin kettle equipped with a nitrogen purge, three-blade impeller, and condenser were charged 521.0 g of water and 0.466 g Aerosol® OT-75 non-vinyl-containing surfactant available from American Cyanamid Company (Parsippany, N.J.). The surfactant solution was heated to 80° C. with stirring, and 1.38 g of ammonium persulfate dissolved in 20.0 g of water was then pumped into the reactor over 5 minutes followed by addition of 7.5 g of water. An emulsion feed of 280 g of water, 8.6 g of Aerosol® OT-75 non-vinyl-containing surfactant, 276.8 g of hydroxethyl acrylate, 276.80 g of styrene, 373.31 g of ethyl acrylate, 0.050 g of octyl mercaptopropionate, and 20.76 g of methacrylic acid was pumped into the reactor over 220 minutes. After the monomer emulsion addition was complete, an additional 16 g of water was pumped into the reactor. The water addition was followed by the addition of 1.0 g of a ferrous sulfate solution (ferrous sulfate complexed with EDTA). A solution of 1.7 g of t-butyl hydroperoxide dissolved in 15.0 g of water and a solution composed of 1.26 g of isoascorbic acid dissolved in 2.0 g of 28% ammonium hydroxide and 13.0 g of water were then pumped into the latex over 15 minutes. The latex was heated for an additional 20 minutes, and 28% ammonium hydroxide was then added to raise the pH to 8.9. The latex was then filtered through a 100-mesh wire screen. The following data was recorded for the latex: dried solids collected through the 100-mesh screen (0.511 g); percent solids in latex (42.20%); pH of latex (8.58); Mn (23,770); Mw (340,600); particle size (175.7 nm (Dn)); Tg (48° C.); minimum film formation temperature (31.4° C.); and surface tension (31 dyne/cm).

### Example 3

### Evaluations of Example 1 and Example 2 as Binders for Corrosion Resistant Coatings

The paint formula used for evaluation can be found in Table 1. It is a high gloss, low Pigment Volume Concentration (PVC) paint formula using a pigment dispersant common to industrial enamels and industrial maintenance coatings. The PVC is defined as the total volume of pigment divided by the total volume of resin, pigment and additives (not including water). The cosolvent choice was 20 phr Butyl Cellosolve™ ethylene glycol monobutyl ether available from Union Carbide Corp. (Danbury Conn.), 15 phr Hexyl Carbitol™ diethylene glycol monohexyl ether available from Union Carbide Corp. (Danbury, Conn.), and 5 phr KP-140 tributoxy ethyl phosphate available from FMC Corp. (Philadelphia, Pa.) where “phr” refers to the grams of solvent per 100 grams of polymer.

The paints were adjusted for viscosity using RM-₈₂₅™ associative thickener available from Rohm and Haas Company (Philadelphia, Pa.) to 80 Kreb units and allowed to equilibrate overnight. The coatings were applied to two different metal substrates for testing. These substrates were bare cold-rolled steel (referred to as “CRS”) and Bonderite™ 1000 iron-phosphate treated cold-rolled steel (referred to as “B1000”) both available from ACT Laboratories, Inc. (Hillsdale, Mich.). Applied films were air-dried in the lab for two weeks before testing. Test results are shown in Table 2.

### Example 4

### Preparation of Clear Coat Formulations

Two clear coat formulations were prepared using the latexes prepared in Examples 1 and 2. The clear coats were formulated by slowly adding a solvent blend of 52.8 phr of water, 13.5 phr of Methyl Carbitol® solvent available from Union Carbide (Danbury, Conn.), and 2.04 phr of Hexyl Cellosolve® solvent available from Union Carbide (Danbury, Conn.) to the latexes of Examples 1 and 2. Immediately after addition of the solvent blend, 15.0 phr of KP-140 was added to the formulation. Wet films of the resulting formulations were cast over 4×12 inch CRS panels using a #50 wire rod. The final dry film thickness of the two films was measured to be about 0.95 mil. No flash rusting was visually observed for the formulation containing the polymer prepared from Hitenol BC-209 in Example 1. On the other hand, flash rusting was visually observed for the formulation that contained the conventional latex prepared in Example 2.

### Coatings Test Procedures

Gloss.

Films were cast over 1B Leneta™ charts available from Leneta™ Company (Mahwah, N.J.) using a 0.003 inch Bird applicator blade giving a 0.003 inch wet film. After aging 14 days at ambient lab conditions, 20° and 60° gloss was measured using a micro-tri-gloss meter from Byk-Gardner USA (Columbia, Md.).

Pencil Hardness.

Films were cast over Bonderite™ 1000 (iron-phosphated) cold-rolled steel panel from ACT Laboratories, Inc. using a wire-wound applicator rod. After aging 14 days, the films were tested for hardness using industry-standard pencil designed for pencil hardness.

Early Water Resistance.

Films were cast over 1B Leneta™ charts using a 0.003 inch Bird applicator blade giving 0.003 inch wet films. After drying for 2 hours, 2.0 mL of deionized water was placed onto the films. After 60 minutes, the spots were observed. Ratings from 1 to 10 were given for changes in color, gloss, blistering, cracking, swelling or softening where 10 represented that no change was apparent.

Chemical Spot.

Films were cast over Bonderite™ 1000 (iron-phosphated) cold-rolled steel panels from ACT Laboratories, Inc. using a wire-wound applicator rod. After aging 14 days, the films were tested. One inch diameter filter paper circles were placed on top of the film and then inundated with reagent. Reagents included methyl ethyl ketone, toluene, brake fluid, Skydrol® hydraulic fluid available from Monsanto Company (Saint Louis, Mo.), 10% aqueous sulfuric acid, 10% aqueous hydrochloric acid, 5% aqueous nitric acid, 10% aqueous sodium hydroxide, 5% aqueous ammonium hydroxide, 50% aqueous ethanol, Formula 409® cleaner available from Clorox Company (Oakland, Calif.), and 50% i-propanol. After 30 minutes, the filter paper was removed and the area was observed for changes in color, gloss, blistering, cracking, swelling, or softening. Ratings of poor, fair, good, or excellent were assigned for each spot.

Salt Spray Testing.

Films were cast over both untreated cold-rolled steel (CRS) and Bonderite™ 100 (iron-phosphate treated) unpolished cold-rolled steel panel from ACT Laboratories, Inc. using a wire-wound applicator rod. After aging 14 days, the films were tested. The dry film thickness was measured using an Elcometer film thickness instrument (Elcometer Instruments, Ltd. Manchester, Great Britain). The bottom ⅓ of each panel face was scratched or scribed with an “X” using a sharp scribing tool similar to an awl. After the back and edges of the panels were wrapped with plastic tape, they were placed into the saltspray cabinet manufactured by Q-Panel Lab Products (Cleveland, Ohio). The tests were run following ASTM B-117-90. The procedure used for rating the creep and undercut corrosion at the scribed area is detailed in ASTM D-1654. Rating for face rust is described in D-610 and blistering is described in D-714, both of which include photographic standards. Ratings were assigned on a scale of 1 to 10 with 10 being the least amount of face rust and blistering. Blister sizes ranged from 8 (very small) to 2 (about ¼ inch), and the densities of blistering ranged from F (few) to M (moderate) to MD (medium-dense) to D (dense).

QUV Exposure.

Films were cast over anodized aluminum panels from ACT Laboratories, Inc. (Hillsdale, Mich.) using a wire-wound applicator rod. After aging 14 days, the films were tested by placing them in the QUV machine (Q-Panel Lab Products, Cleveland, Ohio) using UV-A (340 nm) bulbs. The test is a cyclic UV-exposure and condensing humidity test. The procedure is detailed in ASTM D4587-91. The gloss was measured on intervals using the Byk-Gardner USA tri-gloss meter as described above.

Comparison of the results shows that the reactive surfactant greatly improves the early-water resistance, corrosion-resistance and humidity-resistance of the paint film.

TABL 1
Paint Formulas

| | High Gloss | | |
|---|---|---|---|
| | Enamel with | Paint with | Paint with |
| | Example 1 | Example 1 | Example 2 |
| | Latex | Latex | Latex |
| | Amount Added | Amount Added | Amount added |
| PAINT FORMULA | (% w/w) | (% w/w) | (% w/w) |
| Water | 84.0 | 84.0 | 84.0 |
| Surfynol ® CT-151^{a} | 4.0 | 4.0 | 4.0 |
| Surfynol ® 104DPM^{b} | 1.6 | 1.6 | 1.6 |
| Dehydran ® 1620^{C} | 0.5 | 0.5 | 0.5 |
| DSX ®-1550^{d} | 0.2 | 0.2 | 0.2 |
| TiPure ™ R-706 Ti02^{e} | 200.0 | 200.0 | 200.0 |

The above components were dispersed with high speed to a 7.5 N grind
fineness using a Cowles disperser. Then the following were added:

| Latex wt | 250.0 | 586.9 | 592.4 |
|---|---|---|---|
| (Ex. 1 or Ex. 2) | (42.6% solids) | (42.6% solids) | (42.2% solids) |
| Water | 425 | 88.1 | 82.6 |
| Dehydran ® 1620^{c} | 2.0 | 2.0 | 2.0 |
| Butyl Cellosolve ®^{f} | 50.0 | 50.0 | 50.0 |
| Hexyl Carbitol ®^{g} | 38.0 | 38.0 | 38.0 |
| KP-140 ®^{h} | 13.0 | 13.0 | 13.0 |
| Raybo ™ 60¹ | 3.2 | 3.2 | 3.2 |
| RM-825 ™^{j} | — | 1.0 | 6.0 |
| (Totals) | 1070.5 | 1071.5 | 1071.5 |
| Non-Volatiles | | 44.1% | 44.1% |
| in Paints | | | |

^{a}Dispersant available from Rohm and Haas Company (Philadelphia, Pennsylvania).
^{b}Surfactant available from Rohm and Haas Company (Philadelphia, Pennsylvania).
^{c}Defoamer available from Henkel Corp. (Ambler, Pennsylvania).
^{d}Associative thickener available from Henkel Corp. (Ambler, Pennsylvania).
^{e}Titanium dioxide pigment available from E.I. DuPont de Nemours (Wilmington, Delaware).
^{f}Solvent available from Union Carbide Corp. (Danbury, Connecticut).
^{g}Solvent available from Union Carbide Corp. (Danbury, Connecticut).
^{h}Plasticizer available from FMC Corp. (Philadelphia, Pennsylvania).
ⁱFlash rust inhibitor available from Raybo Chemical Company (Huntington, West Virginia).
^{j}Associative thickener available from Rohm and Haas Company (Philadelphia, Pennsylvania).

TABLE 2
Test Results

| | | High | | |
|---|---|---|---|---|
| | | Gloss | | |
| | | Enamel | Paint | Paint |
| | | with | with | with |
| | | Example | Example | Example |
| - Series I.D. | Test Procedure | 1 Latex | 1 Latex | 2 Latex |
| Gloss (sealed) | 20° | 57 | 52 | 15 |
| | 60° | 84 | 82 | 60 |
| Pencil hardness | 14 day | HB-F | HB-F | HB-F |
| Early Water resist. | 2-hr Dry/60 min spot | no effect | no effect | swelling |
| Chemical Spot | Methyl ethyl ketone | poor | poor | poor |
| 30-minute Spot | Toluene | poor | poor | poor |
| | Brake Fluid | poor | poor | poor |
| | Skydrol ® | poor | poor | poor |
| | 10% H₂SO₄ | excellent | excellent | excellent |
| | 10% HCl | excellent | fair | excellent |
| | 5% HNO₃ | excellent | excellent | excellent |
| | 10% NaOH | excellent | excellent | excellent |
| | 5% NH₃ | excellent | excellent | excellent |
| | 50% Ethanol | good | good | good |
| | Formula 40 ® | good | good | good |
| | 50% i-Propanol | good | good | good |
| Salt spray CRS | hours total: | 156 | 156 | 20 |
| (DFT: 0.8 mil) | Face Rust | 3.0 | 5.0 | 2.0 |
| | Creep | ⅜″ | ⅜″ | 2/8″ |
| Salt spray CRS | hours total: | 440 | 440 | 20 |
| (DFT: 1.3 mil) | Face Rust | 7.0 | 6.0 | 2.0 |
| | Creep | ⅝″ | ⅝″ | 2/8″ |
| Salt spray B1000 | hours total: | 156 | 156 | 47 |
| (DFT: 0.9 mil) | Face Rust | 5.0 | 4.0 | 2.0 |
| | Creep | ⅛″ | 2/8″ | 2/8″ |
| Salt spray B1000 | hours total: | 310 | 310 | 47 |
| (DFT: 1.3 mil) | Face Rust | 4.0 | 6.0 | 2.0 |
| | Creep | 2/8″ | ⅜″ | 2/8″ |
| QUV-A (500 hours) | 20° Gloss retention | 63% | 92% | 67% |
| | 60° Gloss retention | 93% | 105% | 87% |
| Humidity | Rust @ 200 hrs | 10 | 10 | 4 |
| Resistance | Blister @ 200 hrs | 10 | 10 | 8M |

While only a few, preferred embodiments of the invention have been described, those of ordinary skill in the art will recognize that the embodiment may be modified and altered without departing from the central spirit and scope of the invention. Thus, the preferred embodiments described above are to be considered in all respects as illustrative and not restrictive, the scope of the invention being indicated by the following claims, rather than by the foregoing description, and all changes which come within the meaning and range of equivalents of the claims are intended to be embraced.

What is claimed is:

1. A method of inhibiting oxidation on a metal surface, comprising: applying a coating composition comprising a polymer to a metal surface, wherein the polymer comprises at least one surface-active containing macromonomer incorporated into the polymer, and further wherein the oxidation of the metal surface with the applied coating composition is inhibited when the metal surface is contacted with an aqueous salt solution.

2. The method of inhibiting oxidation on a metal surface according to claim 1, wherein the surface-active containing macromonomer has the structure: 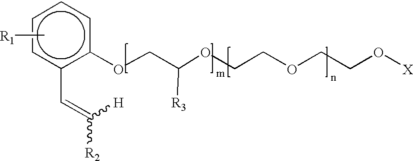
wherein R1 is H, a halogen, or a C₁ to C₂₂ linear or branched chain hydrocarbon group; R2 is H, a halogen, or a linear or branched chain C₁ to C₆ linear or branched chain hydrocarbon; R3 is H, a halogen, or a C₁ to C₆ linear or branched chain hydrocarbon group; m is an integer ranging from 0 to 20; n is an integer ranging from 1 to 50; X is H, SO₃⁻Y, P(═O)(OH)₂, or a deprotonated form of P(═O)(OH)₂; and Y is a cation selected from the group consisting of sodium, lithium, potassium, ammonium, monoalkylammonium, dialkylammonium, trialkylammonium, tetralkylammonium, and combinations thereof.

3. The method of inhibiting oxidation on a metal surface according to claim 1, wherein the polymer further comprises at least one acrylic monomer incorporated into the polymer and at least one aromatic ethylenically-unsaturated monomer incorporated into the polymer.

4. The method of inhibiting oxidation on a metal surface according to claim 3, wherein the polymer further comprises at least one vinyl ester monomer incorporated into the polymer, the vinyl ester monomer having the formula H₂C═C(R₅)—O—C(═O)—R_{6,} wherein R₅ is selected from the group consisting of H, and alkyl groups having from 1 to 5 carbon atoms; and R₆ is an alkyl group selected from the group consisting of alkyl groups having from 1 to 22 carbon atoms.

5. The method of inhibiting oxidation on a metal surface according to claim 4, wherein at least one of the carbon atoms in the alkyl group of R₆ is bonded to at least three other carbon atoms.

6. The method of inhibiting oxidation on a metal surface according to claim 3, wherein the surface-active containing macromonomer is a vinyl aromatic surfactant monomer.

7. The method of inhibiting oxidation on a metal surface according to claim 6, wherein the acrylic monomer is selected from the group consisting of acrylic acid, methacrylic acid, crotonic acid, an ester of acrylic acid, an ester of methacrylic acid, an ester of crotonic acid, a salt of acrylic acid, a salt of methacrylic acid, and a salt of crotonic acid.

8. The method of inhibiting oxidation on a metal surface according to claim 6, wherein the aromatic ethylenically-unsaturated monomer is selected from the group consisting of styrene, vinyltoluene, α-methylstyrene, t-butylstyrene, vinylxylene, and vinyl pyridine.

9. The method of inhibiting oxidation on a metal surface according to claim 6, wherein the polymer is provided in a latex.

10. The method of inhibiting oxidation on a metal surface according to claim 1, wherein the polymer further comprises at least two different acrylic monomers incorporated into the polymer at least one aromatic ethylenically-unsaturated monomer incorporated into the polymer.

11. The method of inhibiting oxidation on a metal surface according to claim 10, wherein at least one of the acrylic monomers is selected from the group consisting of a hydroxyalkyl acrylate and a hydroxyalkyl methacrylate.

12. The method of inhibiting oxidation on a metal surface according to claim 11, wherein the surface-active containing macromonomer is a vinyl aromatic surfactant monomer.

13. The method of inhibiting oxidation on a metal surface according to claim 1, wherein the polymer is substantially free of acetoacetoxy, amine, and enamnine functionalities.

14. The method of inhibiting oxidation on a metal surface according to claim 13, wherein the polymer is substantially free of an incorporated trimethylolpropane triacrylate.

15. The method of inhibiting oxidation on a metal surface according to claim 1, wherein the coating composition is substantially free of any flash rust inhibitor.

16. A method of inhibiting oxidation on a metal surface, comprising applying a coating composition to the metal surface, the coating composition comprising a polymer consisting essentially of:
(a) at least one surface-active containing macromonomer incorporated into the polymer;
(b) at least one acrylic monomer incorporated into the polymer; and
(c) at least one ethylenically-unsaturated aromatic monomer incorporated into the polymer, wherein oxidation of the coated metal surface is inhibited when the metal surface with the applied coating composition is contacted with an aqueous salt solution.

17. The method of inhibiting oxidation on a metal surface according to claim 16, wherein the polymer is substantially free of acetoacetoxy, amine, and enamine functionalities.

18. The method of inhibiting oxidation on a metal surface according to claim 17, wherein the polymer is substantially free of an incorporated trimethylolpropane triacrylate.

19. The method of inhibiting oxidation on a metal surface according to claim 16, wherein at least one acrylic monomer is selected from the group consisting of acrylic acid, methacrylic acid, and crotonic acid.

20. The method of inhibiting oxidation on a metal surface according to claim 16, wherein the coating composition is substantially free of a flash rust inhibitor.

21. A coated metal surface resistant to oxidation, comprising: a metal surface; and a coating composition coated on the metal surface, wherein the coating composition comprises a polymer comprising at least one vinyl-containing reactive surfactant monomer incorporated into the polymer, wherein the oxidation of the metal surface is inhibited when the coated metal surface is contacted with salt water.

22. The coated metal surface resistant to oxidation according to claim 21, wherein the polymer further comprises at least one acrylic monomer incorporated into the polymer and at least one aromatic ethylenically unsaturated monomer incorporated into the polymer.

23. The coated metal surface resistant to oxidation according to claim 21, wherein the polymer is substantially free of acetoacetoxy, amine or enamine functionalities and the polymer is substantially free of any incorporated trimethylolpropane triacrylate.

24. The coated metal surface resistant to oxidation according to claim 21, wherein at least one of the acrylic monomers is selected from the group consisting of a hydroxyalkyl acrylate and a hydroxyalkyl methacrylate.

25. The coated metal surface resistant to oxidation according to claim 21, wherein at least one of the acrylic monomers is selected from the group consisting of acrylic acid, methacrylic acid, and crotonic acid.

26. The coated metal surface resistant to oxidation according to claim 21, wherein the coating composition is substantially free of a flash rust inhibitor.
